(19) United States
(12) Patent Application Publication
(10) Pub. No.: US 2002/0084992 A1
(43) Pub. Date: Jul. 4, 2002

(54) Combined touch panel and display light

(76) Inventor: Stephen S. Agnew, Aldershot (GB)

Correspondence Address: PERMAN & GREEN, 425 POST ROAD, FAIRFIELD, CT, 06430, US

(21) Appl. No.: 09/854,828

(22) Filed: May 14, 2001

Related U.S. Application Data
(63) Continuation-in-part of application No. 09/751,686, filed on Dec. 29, 2000, now abandoned.

(51) Int. Cl. G09G 5/00

(52) U.S. Cl. 345/173

(57) ABSTRACT

A combined touch panel and lighting for use with a display having a substantially planar surface, comprising a source of illumination; a light guide for receiving light from the source of illumination and for propagating light partly in a direction substantially parallel to a display surface of the display; and at least one sensor for detecting an interruption in propagation of light in a direction substantially parallel to the display surface. A signal combiner, which may be an integrated circuit, may be used to combine signals from sensors to determine the position at which the panel was touched.

This application is a continuation-in-part of application Ser. No. 09/751,686 filed on Dec. 29, 2000.

### FIELD OF THE INVENTION

This invention relates to displays. In particular it relates to Liquid Crystal Displays (LCD's) having an illumination source and a touch panel.

### BACKGROUND ART

LCD's, and in particular LCD's such as those used in mobile devices, generally require some form of illumination to be seen. Sometimes the ambient light is sufficient. When it is not, such as when the user of the device is in a dark room, or is outdoors at night, a light source must be provided. Generally, a side illumination device, such as an LED is used to provide illumination for viewing under such limited light conditions.

Often the display in such devices presents data in a pictorial or graphic form which would be a useful display for a touch screen, to allow users to control the device by, for example, selecting certain functions or directing that the device display other data. It is of course possible to provide a separate touch sensitive screen, with appropriate associated electronics, to allow touch sensitive operation to occur. However, most touch screens use separate capacitively or mechanically sensitive layers of material, which not only significantly increase the cost of the device to which they are attached, but also add to size and complexity. Further, of great significance, such devices tend to reduce the optical performance of the display by absorbing some of the light, or diffusing it somewhat, thereby decreasing brightness and/or contrast.

Thus, it would be desirable to have an apparatus useful as both an illumination element, and a touch screen, to allow cost and complexity to be minimized and optical performance to be maximized, or at least not reduced.

### SUMMARY OF THE INVENTION

It is an object of the invention to provide an apparatus useful as both an illumination element for a display screen, and a touch screen.

It is another object of the invention to provide such a device which is simple, efficient and does not unduly increase size or weight, or degrade optical performance.

It is yet another object of the invention to provide an apparatus which makes maximum use of components already available in portable display devices.

In accordance with the invention, a combined touch panel and lighting for use with an LCD display having a substantially planar surface is provided, comprising a source of illumination; a light guide for receiving light from the source of illumination and for propagating light partly in a direction substantially parallel to a display surface of the display; and at least one sensor for detecting an interruption in propagation of light in a direction substantially parallel to the display surface.

The light guide may comprise at least one of prisms and lenses and distributes the illumination so that at least a portion of the illumination travels in two perpendicular directions. The light guide may distribute the light in a plurality of different paths, at least one sensor being positioned to receiving illumination from each path. The paths may be substantially parallel. Alternatively, the illumination may radiate from one point, or in a more or less linear manner, adjacent to one or more of the display edges, wherein the path extends over a substantial portion of the display surface. A plurality of sensors disposed along at least one edge of said display surface. A combiner may be used for combining outputs of the sensors and for defining a location of an interruption of illumination of at least one of the plurality of sensors or a group of sensors.

The source of illumination may be one of a light emitting diode or alternative light source such as cold-cathode fluorescent light (CCFL).

The light guide may extend about at least a portion of a periphery of the display. It may also be a substantially planar member extending over or under the display surface.

The light guide may be formed of a resilient, deformable material which conducts light to the at least one sensor. Alternatively, the apparatus of the invention may further comprise a resilient, deformable substantially planar layer of material which conducts light to the at least one sensor, the layer being disposed over the display. Another alternative is that light be guided over the surface of the display (the protective window thereof, or light guide as used in the case of front illumination) such that by physically placing an object in the light path the light would be blocked and this action could be detected. Thus in this case no deformable material is needed to apply the invention, nor need any pressure be applied to create a touch, resulting in a compact, robust device.

In accordance with the invention, the apparatus may be used in combination with a display panel, the apparatus being sized, shaped and positioned to illuminate the display panel, which may be a liquid crystal display, and may be lighted from the front or back. The resulting display may be used in combination with any mobile electronic device such as an electronic book reader, a personal digital assistant or a telephone, and in particular a mobile telephone.

### BRIEF DESCRIPTION OF THE DRAWINGS

The foregoing aspects and other features of the present invention are explained in the following description, taken in connection with the accompanying drawings, wherein:

FIG. 1 is a plan view of a display in accordance with a first embodiment of the invention.

FIG. 2 is a cross section of the display of FIG. 1, taken along line 2-2 of FIG. 1.

FIG. 3 is a plan view of a display in accordance with a second embodiment of the invention.

FIG. 4 is a cross sectional view of the display of FIG. 3, taken along line 4-4 of FIG. 3.

FIG. 5 is a block diagram of a signal processing circuit which determines the location of a contact with the touch screen.

### DETAILED DESCRIPTION OF THE PREFERRED EMBODIMENTS

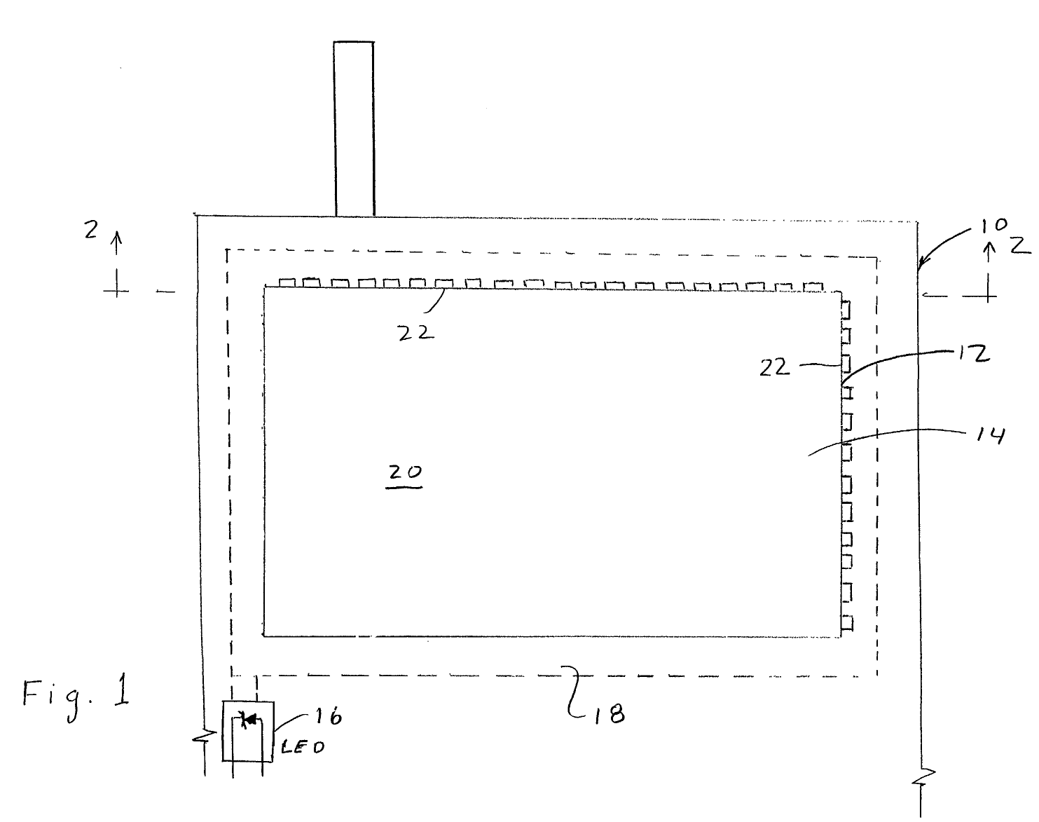

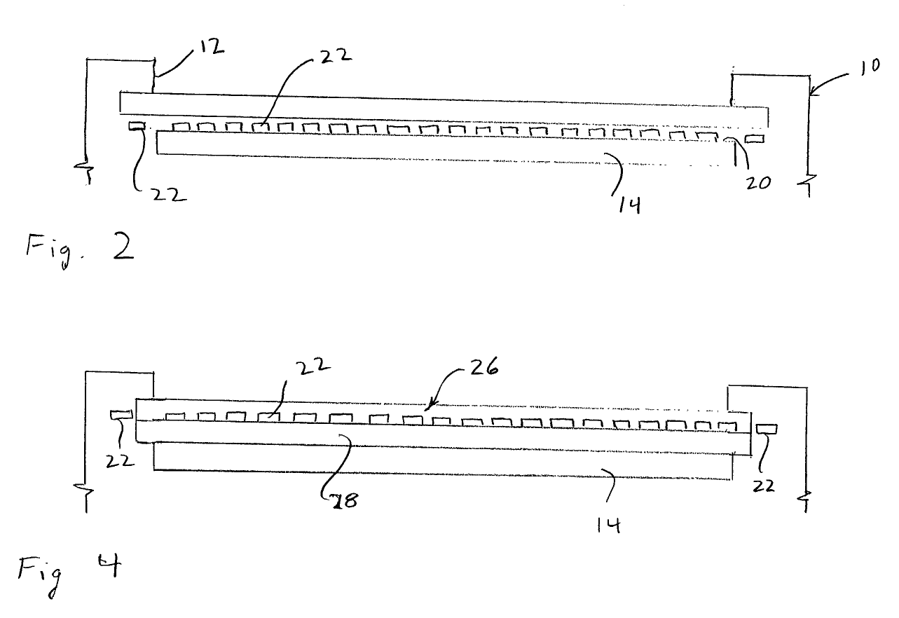

Referring to FIG. 1 and FIG. 2, a device such as a mobile phone has a housing 10 with an opening 12 through which a user may observe a display panel 14, such as a liquid crystal display. In some devices, the display may be illuminated from behind, whereas the touch element must always be in front of the display, in which case the only common parts of the touch panel and lighting would the light source and coupling elements. Further integration is possible when front lighting is applied. Front illumination is, in general, well known in the art.

In accordance with the first embodiment of the invention in FIG. 1 and FIG. 2, an light source 16, such as a light emitting diode (LED) provides illumination to a light guide 18, which provides light for front illumination of display panel 14. It will be understood that while a single source of illumination has been shown in FIG. 1, it is possible to use multiple sources distributed along light guide 18, or a substantially continuous source to aid in uniformly distributing the illumination.

Light guide 18 is designed to conduct light from source 16 across the area of the light guide and to alter the direction of the light downward into the display. Some of the light travelling across the light guide surface will exit to the edges of the light guide opposite the light source 16.

A plurality of light sensors 22, such as photodiodes or miniature photocells, are positioned along the periphery of opening 12 to detect light from light guide 18 that is, in general, traveling in a direction parallel to surface 20 of display panel 14. As shown in FIG. 1, these sensors may be positioned along two adjacent sides of opening 12; that is in both the X and Y directions of display panel 14.

If display panel 14 is touched by an object, such as a finger or stylus, illumination traveling parallel to surface 20 of display panel 14 will be blocked, thus changing the level of illumination to some of sensors 22. As a result, it is possible to determine the position of the object blocking the illumination, by use of, for example, a logic circuit, as more fully described below with respect to FIG. 5.

The advantage of the arrangement according to the invention shown in FIG. 1 and FIG. 2 is that no separate touch screen panel or illumination source, other than as required for illumination of display panel 14, is needed. In general, some circuit, such as that described with respect to FIG. 5, would be needed with any touch screen arrangement, in any event. Thus, complexity, size and cost are reduced or not unduly increased, while optical performance of the display is not degraded in any way.

It will be understood that various modifications of the arrangement of FIG. 1 and FIG. 2 are possible. If sensing in only one direction is needed, the sensors need only extend along one side opposite the source of the illumination. The exact positioning of the sensors can be customized to fit particular display needs, with possible economy in the number of sensors used.

Another possibility is that light guide 18 may be configured, with for example, a series of prisms and lenses, to emit concentrations of light only at discreet intervals which are at locations opposite the locations of sensors 22, thus creating a series of substantially parallel beams that are interrupted by the presence of a finger or stylus. The resolution of the position of the input would be approximately that of the number of paths, or two times this with some post processing of sensor outputs. An element of pressure sensing may be incorporated, where heavier pressure disrupts more than one beam. In this case, the sensors may work in a digital mode, where only threshold detection is used. Alternatively, applied pressure may be calculated from the relative drop in light intensity as measured from analog output of a sensor or sensors.

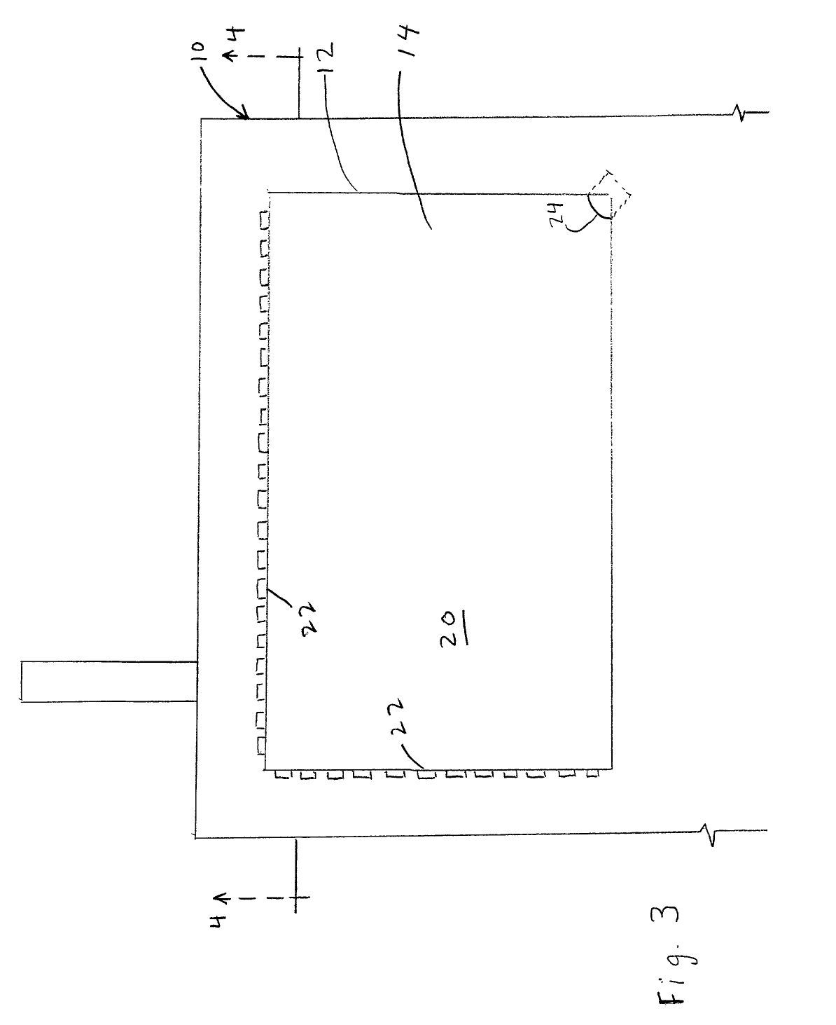

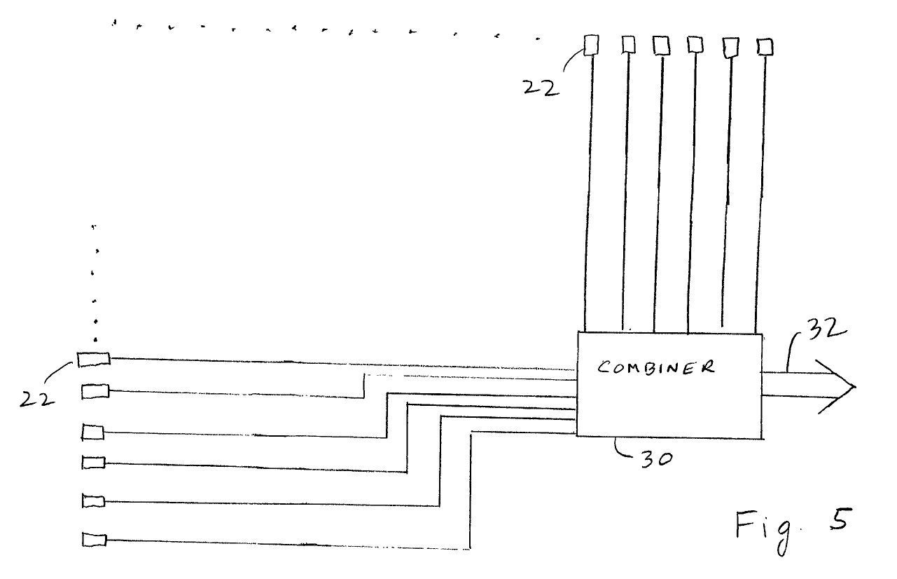

In a second embodiment of the invention illustrated in FIG. 3 and FIG. 4, a single light source 24 is used to illuminate display panel 14. Display panel 14 has, disposed over its top surface 20, a relatively soft and deformable light transmissive layer 26, which may be formed of a transparent, plasticized polymer. Layer 26 functions as the light guide for illumination of display panel 14, but also provides illumination for sensors 22. As in the first embodiment of the invention, illumination is conducted parallel to, and in close proximity to, surface 20 of display panel 14. Mechanical deformation of layer 26 caused by touching it, decreases the level of light transmitted past the resulting region of depression. Sensors 22, which receive less light, provide signals, which can be used to determine the location of the object touching layer 26.

The resolution with which the co-ordinates of a point of touch can be determined will depend on the number of sensors, but may vary across the display surface. Individual sensors need not be used at the same resolution as the display pixel size, if the sensors are placed at the edge of the display module (outside the active region of the display) and the input from different sensors is combined. The integration of sensor inputs enables much greater resolution of the shadow region created and thus a determination of the point of origin of the applied touch.

Display design can efficiently use the configuration of FIG. 3 and FIG. 4 by placing soft keys (requiring low resolution) and regions reserved for character input (requiring higher resolution) at strategic locations on the display, although this is a restriction on freedom of design of a User Interface (UI). In regions where high resolution is required, sensor spacing must be reduced. In this mode the sensors must detect level (operate in analogue mode), although absolute value is not important, while the relative change across several sensors is of importance. Multiple light sources may also be used without creating any problem for this scheme, provided the sensors have sufficient sensitivity. It is also possible to have a light-pipe along one side and sensors on the opposite side so that the shadow caused by a touch may be analyzed to detect both x and y position. In practice, the touch response could be calibrated before use. Again an element of pressure can also be detected.

A possible disadvantage of the structure of FIG. 4 is that layer 26 may cause some loss in optical performance. However, if the material is properly chosen, such loss will be minimal.

A variation in the embodiment of FIG. 3 and FIG. 4 is that it is possible to use two layers of material over display panel 14. The first one, in contact with surface 20, may be a hard material 28 of the type presently used for light guides. Thus, this is a light guide of planar form, primarily for illuminating display panel 14. The second may be a softer, outer layer, which also conducts light input, but primarily across the surface of the display and parallel to surface 20. Deformation of this outer layer causes a shadow at the detecting side or sides where sensors 22 are located.

Referring to FIG. 5, the outputs of sensors 22 are provided to a unit which serves as a combiner 30, which logically combines the inputs from sensors 22 to make a determination of the position on display panel 14 which has been touched by a finger or stylus. The computed output may be provided in digital form as a plurality of bits (the number of bits being based on the precision required) on an output bus 32.

It will be understood that by substantially planar, it is meant that, in principal, display panel 14 may have some curvature. Also, by substantially parallel, it is meant that illumination does not have to be precisely parallel to display panel 14, but can travel at some angle with respect to its surface, depending on the location of, for example, the illumination source and the sensors. Also, by close proximity, it is meant that the illumination travels generally along the surface of the display panel. Thus, it may be possible to detect a near touch, and its location, if contact with the surface is not actually made, due to a shadow falling on, for example the sensors of the an embodiment such as that of FIG. 1 and FIG. 2.

It will also be understood that while the present invention has been described with respect to an LCD using a front light, in principle, it may be applied to other display technologies. For example, while not as advantageous, it may be used with appropriate modification, with a back lit display. Such modification may include sensors having a restricted angle of light reception, or a spectral sensitivity different from that used to illuminate the display. A filter may be used to provide different portions of the spectrum from a single light source, which provides both illumination of the display, and illumination for the position sensors.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A combined touch panel and light for use with a display having a substantially planar surface, comprising:
a source of illumination;
a light guide for receiving light from said source of illumination and for propagating light in a direction substantially parallel to a display surface of said display; and
at least one sensor for detecting an interruption in propagation of light in a direction substantially parallel to said display surface.

2. The apparatus of claim 1, wherein said lightguide comprises at least one of prisms and lenses.

3. The apparatus of claim 1, wherein the lightguide distributes the illumination so that at least a portion of the illumination travels in two perpendicular directions.

4. The apparatus of claim 1, wherein the lightguide distributes the light in a plurality of different paths; and a sensor is positioned to receiving illumination from at least one of said paths.

5. The apparatus of claim 4, wherein the paths are substantially parallel.

6. The apparatus of claim 1, wherein said illumination radiates from one point.

7. The apparatus of claim 1, wherein said illumination radiates in a substantially linear manner, adjacent to at least one edge of the display.

8. The apparatus of claim 6, wherein said at least one sensor is an analog sensor.

9. The apparatus of claim 1, wherein said at least one sensor is a threshold detection sensor.

10. The apparatus of claim 1, wherein said at least one sensor comprises a plurality of sensors disposed along at least one edge of said display surface.

11. The apparatus of claim 11, further comprising:
a combiner for combining output s of said sensors and for defining a location of an interruption of illumination of at least one of said plurality of sensors.

12. The apparatus of claim 11, said combiner defines a location of an interruption of illumination of a group of said sensors.

13. The apparatus of claim 1, wherein said source of illumination is a light emitting diode.

14. The apparatus of claim 1, wherein said light guide comprises a substantially planar member extending over said display surface.

15. The apparatus of claim 1, wherein said light guide is formed of a resilient, deformable material which conducts light to said at least one sensor.

16. The apparatus of claim 15, further comprising a resilient, deformable substantially planar layer of material which conducts light to said at least one sensor, said layer being disposed over said light guide.

17. The apparatus of claim 1, in combination with a display panel, said apparatus being sized, shaped and positioned to illuminate said display panel.

18. The apparatus of claim 17, wherein said display panel is a liquid crystal display panel.

19. The apparatus of claim 17, wherein said liquid crystal display panel is front illuminated by said illumination.

20. The apparatus of claim 17, wherein said liquid crystal display panel is back illuminated by said illumination.

21. The apparatus of claim 17, in combination with a portable electronic device, said portable electronic device being interfaced to said apparatus to provide a display on said display panel.

22. The apparatus of claim 21, wherein said portable electronic device is a personal digital assistant.

23. The apparatus of claim 21, wherein said portable electronic device is an electronic book reader.

24. The apparatus of claim 21, wherein said portable electronic device is a mobile telephone.

25. The apparatus of claim 17, in combination with a telephone, said display panel being at least a part of a user interface of said telephone.

26. The apparatus of claim 25, wherein said telephone is a mobile telephone.
